(19) United States
(12) Patent Application Publication
(10) Pub. No.: US 2010/0106552 A1
(43) Pub. Date: Apr. 29, 2010

(54) ON-DEMAND ACCESS TO TECHNICAL SKILLS

(75) Inventor: Franck Barillaud, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 12/258,971

(22) Filed: Oct. 27, 2008

(51) Int. Cl. G06Q 10/00; G06Q 50/00

(52) U.S. Cl. 705/9; 705/8

(57) ABSTRACT

A method, system, and computer program product for providing a user with intelligent access to a skilled consultant. In response to receiving a user input describing an issue about which consultation is desired, the method includes mapping the user input to one or more selected problem domains. Based on a list of skill(s) for consulting in the selected problem domain, the selected problem domain is mapped to a consultant set of one or more consultants associated with the skill(s). The consultant set is filtered to determine whether consultant(s) in the consultant set are available to consult utilizing communication via a data processing system (DPS). A consultation request is sent to available consultant(s) in the consultant set. In response to receiving, from an available consultant, an acceptance of the consultation request, the consulting information is communicated between the available consultant and the user in substantially real time via the DPS.

### BACKGROUND OF THE INVENTION

The present disclosure relates to customer service systems, and specifically, to a method, system, and computer program product for providing a user with intelligent access to a skilled consultant.

For business entities (e.g., vendors) having numerous employees located in multiple divisions worldwide, providing skilled assistance to users (e.g., customers) on a timely basis on a variety of matters can be challenging. During the course of a typical work day, issues might arise where skilled assistance is required. These issues might relate to a plurality of business related communities including, but not limited to computing, information technology, finance, manufacturing, engineering, health and safety, legal, and corporate.

Technical support services and programs are designed to diagnose and solve technical problems that customers encounter. As businesses continue to move on-line, distributed computing environments become more complex and, thus, more difficult to troubleshoot. Indeed, entire businesses are now connecting their critical business systems directly to employees, customers, vendors and other important constituencies. To this end, many internal or external business network applications are now being connected to the Internet's World Wide Web (WWW) to make the information accessible from anywhere using conventional browser software.

Traditional technical support centers place their emphasis on internal tracking and productivity tools, such as problem tracking systems. Such systems exist internally to the support organization and are usually transparent to the user (i.e., customer). Although current back-end systems aid internal efficiency, they do little for the actual problem resolution process itself, since the user is not allowed to evaluate the effectiveness of the customer service. Problem resolution is typically left to telephony-based technologies such as agent-based automatic call distribution (ACD) support centers and intelligent voice response (IVR) devices.

The most common method of technical support is still a telephone conversation with technical support personnel. Other known techniques, when applicable (e.g., computing issues), involve a network “login” to the customer's remote node so that the conditions may be evaluated from the technical support center's viewpoint. The network connection may be used to run a diagnostic program on the remote node, or “self-help” fix-it programs may be downloaded to the remote node and executed there.

With the explosive growth of the Internet, yet another approach involves having the user access a Web server with support content in the form of support notes or Frequently Asked Questions (FAQs). The user attempts to use this information to “self-service” his or her own problem. On its face, this strategy appears sensible as, theoretically, an effective self-service strategy would let users solve problems for themselves (e.g., through a Web browser), with the result of lower call volumes and better service. Unfortunately, however, using the Web as a publishing medium has not resulted in the desired benefits. Indeed, call avoidance has often evolved into “customer avoidance”. In particular, most normal users do not want to be “detectives” who have to make a set of guesses about the precise search strings that will get them to the right support solutions. Further, it is quite frustrating for users who cannot solve their problems (by self-service) to then be forced to go through the tedious exercise of later repeating to a technical support representative information concerning their self-service attempts.

According to another Web-based alternative, many customer service departments also provide “live chat” sessions, which require a user to physically type-in their technical issue. When an event occurs that indicates that the online user may be assisted by chatting with a consultant (e.g., customer service agent) online, a chat application contacts the chat server and places the user in a queue to chat with the next available customer service agent. Waiting for a live chat session to begin can prove even more fruitless and frustrating for users who eventually discover that the question/issue they have posed to the live chat agent is beyond the capabilities of the agent. Thus, many “technical problems” have very complex diagnoses and resolutions that either (a) fall outside the skill set of the customer service agent, or (b) exceed the proficiency skill level of the customer service agent.

In view of the foregoing, the result is that end users often feel like the vendor is trying to push them away. Moreover, the end user will eventually turn to other vendors in search of a better customer service experience. Such unintended consequences can translate into lost revenues and higher costs for the vendor.

### BRIEF SUMMARY OF THE INVENTION

In view of the foregoing, a method, system, and computer program product for providing a user with intelligent access to a skilled consultant are disclosed. According to one or more embodiments of the invention, in response to receiving a user input describing an issue about which consultation is desired, the user input is mapped to one or more selected problem domains from among a plurality of problem domains. Based on a list of one or more skills for consulting in the selected problem domain, the selected problem domain is mapped to a consultant set of one or more consultants associated with the one or more skills. The consultant set is filtered to determine whether one or more consultants in the consultant set are available to consult utilizing communication via a data processing system (DPS). A consultation request is sent to one or more available consultants in the consultant set. In response to receiving, from an available consultant, an acceptance of the consultation request, the consulting information is communicated between the available consultant and the user in substantially real time via the DPS.

All features of the present embodiments of the invention will become apparent in the following detailed written description.

### BRIEF DESCRIPTION OF THE DRAWINGS

Aspects of the invention itself will best be understood by reference to the following detailed description of an illustrative embodiment when read in conjunction with the accompanying drawings, where:

FIG. 1 illustrates one embodiment of a network including a client and server system, wherein an embodiment of the invention can be practiced;

FIG. 2 depicts an exemplary computing environment in which the present invention may be implemented;

FIG. 3 illustrates one embodiment of a Skilled Consultant Help (SCH) system block diagram in accordance with one embodiment; and

FIGS. 4A, 4B, 4C, and 4D together form a high level logical flowchart of an exemplary method for providing a user with intelligent access to a skilled consultant, according to an embodiment of the invention.

### DETAILED DESCRIPTION OF THE DRAWINGS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a tangible computer-usable storage medium having computer-usable program code embodied in the storage medium and processible by a computer.

Any suitable tangible computer-usable or computer-readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber cable, RF, etc.

Computer program code for carrying out operations of the present invention may be written in an object oriented programming language such as JAVA®, Smalltalk® (SMALLTALK is a trademark or registered trademark of Cincom Systems, Inc.), C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

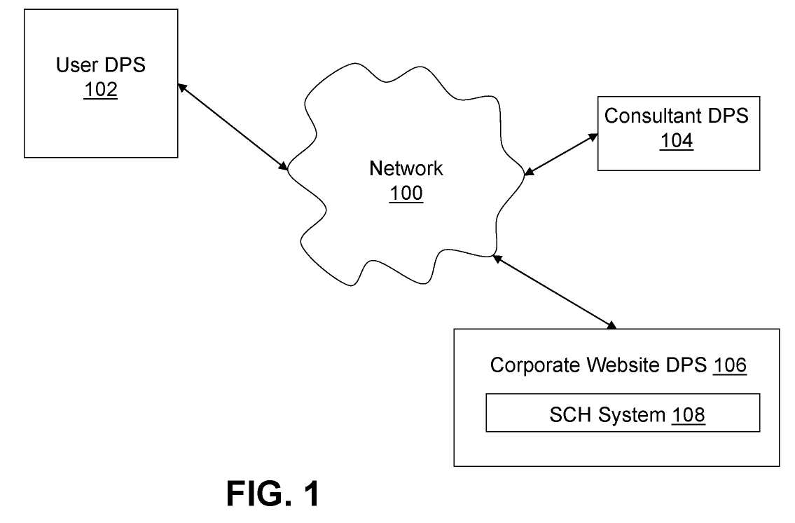

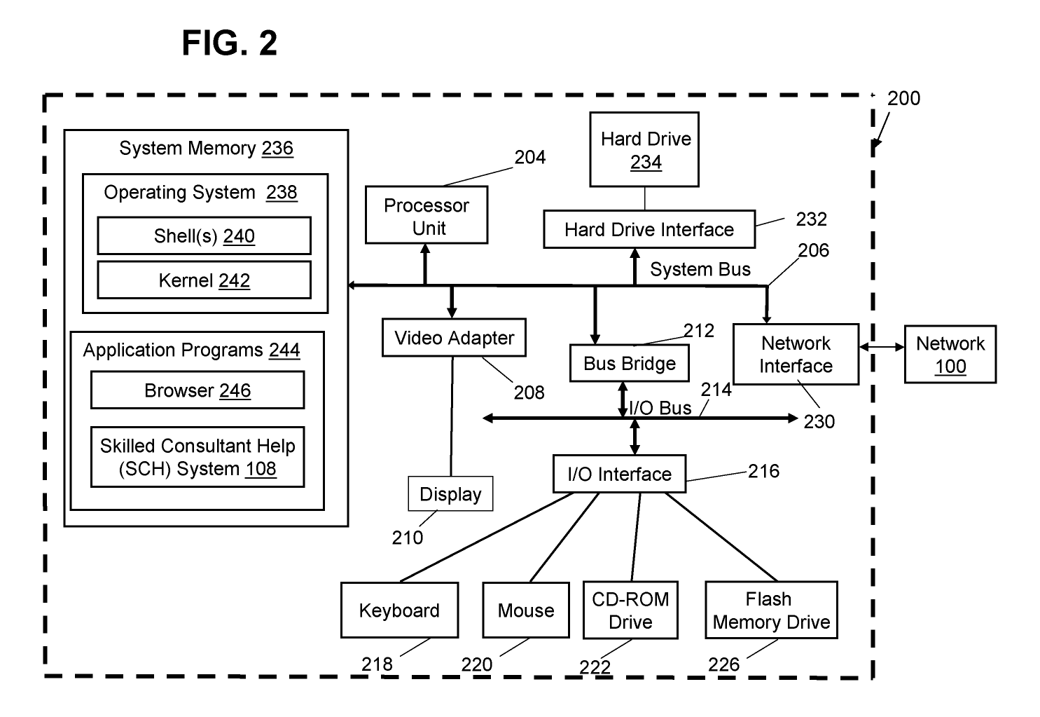

With reference now to the figures, and in particular to FIG. 1, there is depicted an exemplary computer network 100 of a client and server system, wherein an embodiment of the invention can be practiced. On the client side, a customer DPS 102 is coupled to network 100. A user operating customer DPS 102 has access to consultant DPS 104 and a corporate website DPS 106, through network 100. Consultant DPS 104, operated by a consultant, is also coupled to network 100. The consultant may be a customer service representative, another customer, an automated system, or any other mechanism that provides help to the user. On the server side, corporate website DPS 106 includes a Skilled Consultant Help (SCH) system 108. The general architecture of customer DPS 102, consultant DPS 104, and corporate website DPS 106, according to one embodiment, is discussed below in FIG. 2.

Referring now to FIG. 2, there is depicted a block diagram of an exemplary data processing system (DPS) 200, with which the present invention may be utilized. DPS 200 includes a processor unit 204 that is coupled to a system bus 206. A video adapter 208, which drives/supports a display 210, is also coupled to system bus 206. System bus 206 is coupled via a bus bridge 212 to an Input/Output (I/O) bus 214. An I/O interface 216 is coupled to I/O bus 214. I/O interface 216 affords communication with various I/O devices, including a keyboard 218, a mouse 220, a Compact Disk-Read Only Memory (CD-ROM) drive 222, and a flash memory drive 226. The format of the ports connected to I/O interface 216 may be any known to those skilled in the art of computer architecture, including but not limited to Universal Serial Bus (USB) ports.

DPS 200 is able to communicate to other remote DPSs (not shown) via a network 100 (FIG. 1) using a network interface 230, which is coupled to system bus 206. Network 100 may be an external network such as the Internet, or an internal network such as an Ethernet or a Virtual Private Network (VPN).

A hard drive interface 232 is also coupled to system bus 206. Hard drive interface 232 interfaces with a hard drive 234. In one embodiment, hard drive 234 populates a system memory 236, which is also coupled to system bus 206. System memory 236 is defined as a lowest level of volatile memory in DPS 200. This volatile memory may include additional higher levels of volatile memory (not shown), including, but not limited to, cache memory, registers, and buffers. Code that populates system memory 236 includes an operating system (OS) 238 and application programs 244.

OS 238 includes a shell 240, for providing transparent user access to resources such as application programs 244. Generally, shell 240 (as it is called in UNIX® (UNIX is a registered trademark of The Open Group)) is a program that provides an interpreter and an interface between the user and the operating system. Shell 240 provides a system prompt, interprets commands entered by keyboard 218, mouse 220, or other user input media, and sends the interpreted command(s) to the appropriate lower levels of the operating system (e.g., kernel 242) for processing. As depicted, OS 238 also includes kernel 242, which includes lower levels of functionality for OS 238. Kernel 242 provides essential services required by other parts of OS 238 and application programs 244. The services provided by kernel 242 include memory management, process and task management, disk management, and I/O device management.

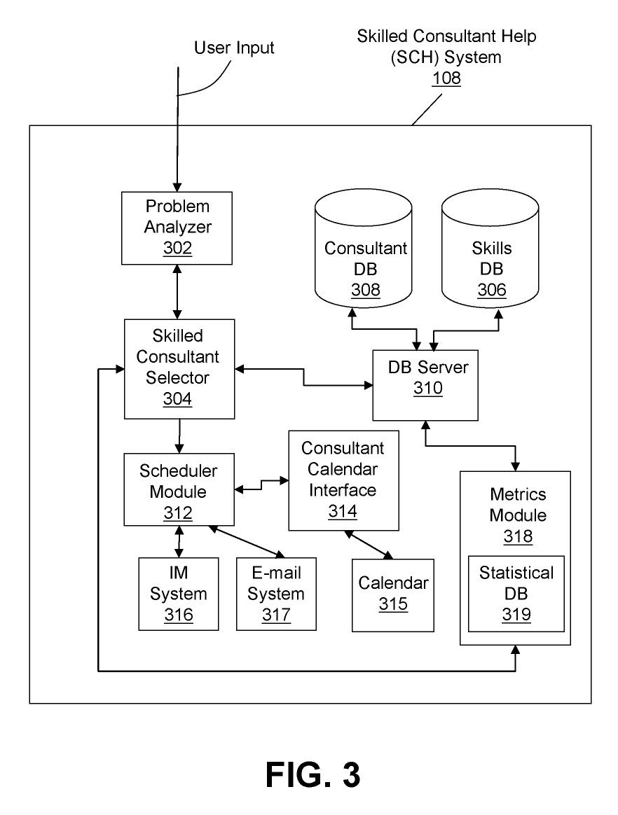

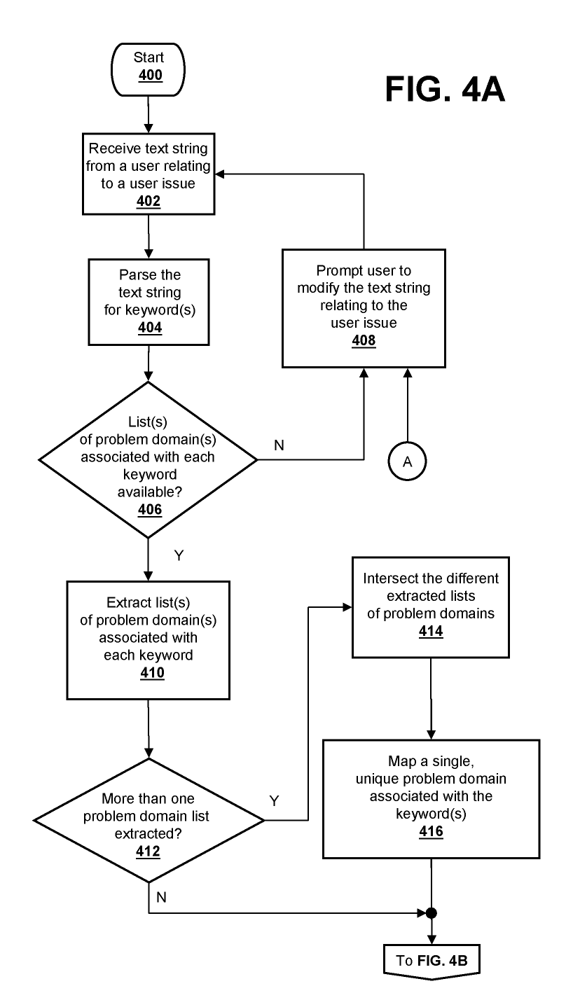

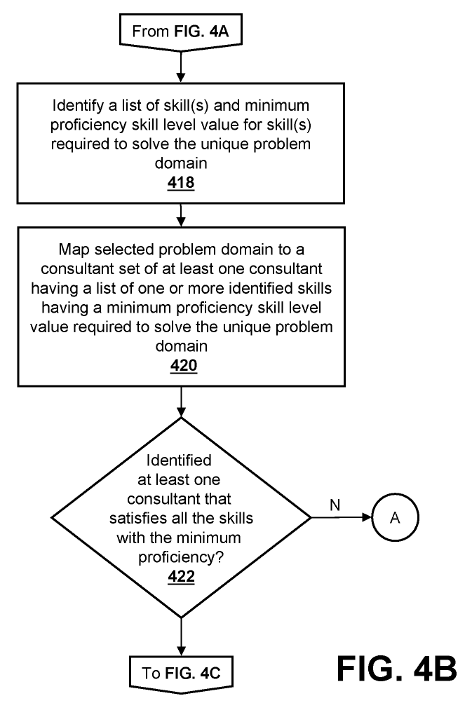

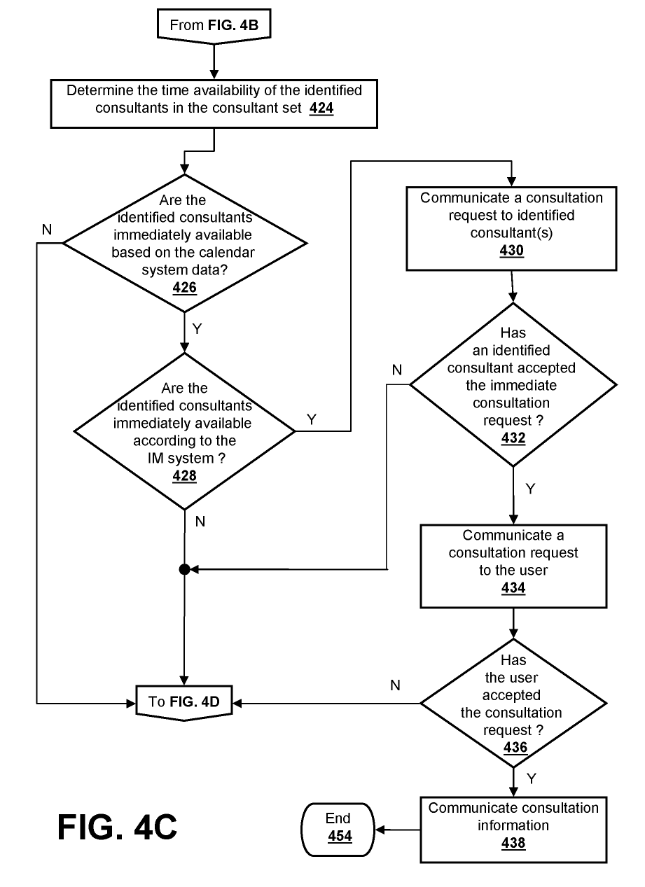

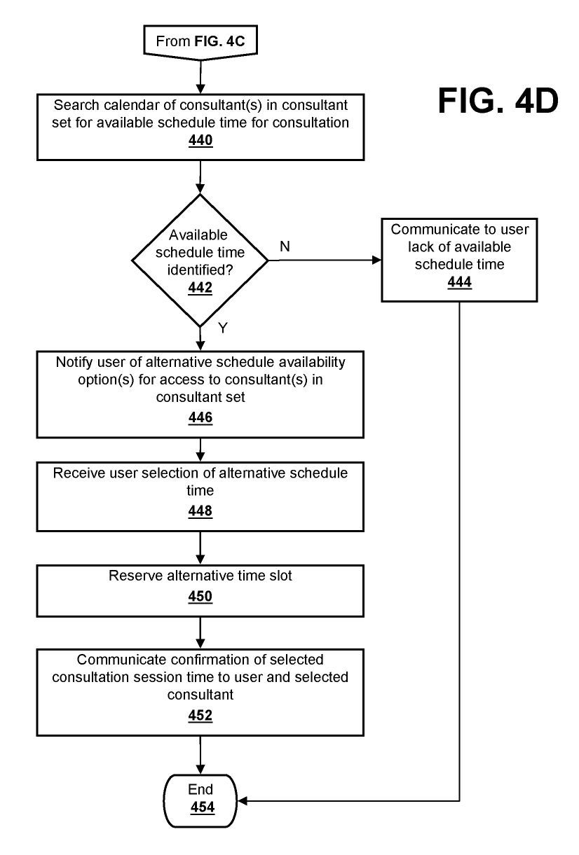

Application programs 244 include a browser 246. Browser 246 includes program modules and instructions enabling a World Wide Web (WWW) client (i.e., DPS 200) to send and receive network messages to the Internet. DPS 200 may utilize HyperText Transfer Protocol (HTTP) messaging to enable communication with remote servers. Application programs 244 in system memory 236 also include a Skilled Consultant Help (SCH) system 108 (FIG. 1). SCH system 108 performs the functions illustrated below in FIGS. 4A-4D, and may include all logic, helper functions, databases and other resources depicted in FIGS. 1 and 3. SCH system 108 processes electronic signals from a multitude of sources within network 100. Although the client-server embodiment described earlier in FIG. 1 shows SCH system 108 as being implemented entirely within the general architecture of corporate website DPS 106, it should be recognized that alternative implementations are possible. For example, the elements of SCH system 108 can be implemented entirely or partly within customer DPS 102 (FIG. 1), consultant DPS 104 (FIG. 1), and/or corporate website DPS 106 (FIG. 1). In this regard, the invention is not limited to client-server implementations, but rather other networking models, such as peer-to-peer, can be adopted.

The hardware elements depicted in DPS 200 are not intended to be exhaustive, but rather represent and/or highlight certain components that may be utilized to practice the present invention. For instance, DPS 200 may include alternate memory storage devices such as magnetic cassettes, Digital Versatile Disks (DVDs), Bernoulli cartridges, and the like. These and other variations are intended to be within the spirit and scope of the present invention.

FIG. 3 illustrates a block diagram of one embodiment of SCH system 108 (FIG. 1). At a front-end of SCH system 108, the user submits user input via customer DPS 102 (FIG. 1) to corporate website DPS 106 (FIG. 1). The user input describes an issue about which consultation is desired. Moreover, it is assumed that the issue can be resolved through consultation with a skilled consultant that is accessible through a consultant DPS 104 (FIG. 1). According to an embodiment of the disclosure, such user input can include a text string. However, it should be recognized that the user input can take on additional or alternative different forms, including, but not limited to (a) an audible word or phrase, (b) graphical selection, and (c) a problem selection that is selected from among a set of predetermined problem categories presented to the user.

The entrance to the back-end of SCH system 108 is through problem analyzer 302. Problem analyzer 302 receives the user input from the user and maps the user input to one or more problem domains. A problem domain is an abstract view of the specific problem at hand. Problem analyzer 302 passes the problem domain data to a skilled consultant selector 304. Skilled consultant selector 304 accesses a skills database 306 and a consultant database 308, via a database server 310. Based on the problem domain that is selected by problem analyzer 302, skilled consultant selector 304 retrieves a required set of skills from skills database 306. Moreover, each skill is associated with a minimum proficiency skill level value in order to solve the selected problem domain. From consultant database 308, a consultant set of consultants having the requisite skill(s) and minimum proficiency skill level value for each skill in skills database 306 is mapped to the selected problem domain.

After the consultant set has been identified from the data provided by skills database 306 and consultant databases 308, a scheduler module 312 filters the consultant set to determine whether one or more of the skilled consultants are available to consult with the user. Scheduler module 312 interfaces with a consultant calendar interface 314 to determine which, if any, of the skilled consultants of the consultant set are immediately available to consult with the user. This determination is based upon a calendar 315 of the skilled consultant(s) in the consultant set. Such calendar systems include, but are not limited to IBM® Lotus(& Notes®, Microsoft® Office® Outlook®, and any other type of application for accessing calendar information from a consultant.

In addition, scheduler module 312 interfaces with an instant messaging (IM) system 316 to determine whether the skilled consultant(s) of the consultant set are immediately available to communicate with user utilizing communication via IM system 316. Scheduler module 312 directly queries the skilled consultant(s) in the form of a consultation request, which in at least some embodiments may or may not be accepted by one of the skilled consultant(s) of the consultant set. Once the consultation request is accepted by an available consultant, a consultation session is initiated between the available consultant and the user via IM system 316.

However, if scheduler module 312 determines that no skilled consultant is immediately available to assist the user, scheduler module 312 searches, via consultant calendar interface 314, the calendar 315 of one or more skilled consultants of the consultant set to identify available schedule time(s) for consultation. Scheduler module 312 extracts the available schedule time(s) and presents the available schedule time(s) of the various skilled consultants to the user. In this regard, an e-mail system 317 coupled to scheduler module 312 is used to communicate the available schedule time(s) to the user. Scheduler module 312 receives a selected available schedule time from the user and creates a calendar entry in calendar 315 for a tentative consultation session between the user and the skilled consultant that is available during the selected schedule time. According to an embodiment of the invention, the consultation session is conducted via IM system 316. IM systems can include, but is not limited to an Enterprise Instant Messaging (EIM) Server or a Consumer Instant Messaging (CIM) Server. Examples of IM systems according to embodiments of the present invention may include, but are not limited to, IBM® Lotus® Sametime®, DBabble—Chat Server and Instant Messaging Software, Microsoft® Office® Communications Server 2007, Cisco® Unified Presence Server™ and Unified Personal Communicator™, Avaya® one-X™ software, and Siemens® OpenScape®.

In addition, a metrics module 318 is coupled to skilled consultant selector 304 and database server 310. Metrics module 318 tracks the overall efficiency and success of the consultation session between the user and the skilled consultant. According to one embodiment of the invention, metrics module administers a satisfaction survey to the user. The results of the satisfaction survey are inputted into metrics module 318. In this regard, the user can input the degree to which the consultant was able to address the problem or issue for which the consultant was selected to address. Depending on the inputted values, metrics module 318 can control, for example, whether (a) the proficiency skill level value associated with the selected consultant should be changed in consultant database 308, (b) a performance component of consultant compensation should be changed and/or (c) the required skill set associated with the selected problem domain should be changed. In addition, metrics module 318 tracks the level of success in mapping a problem domain from among multiple problem domain lists. The data that is collected by metrics module 318 and stored within a statistical database 319 for tracking mapping success is termed statistical priority data, and is utilized by problem analyzer 302 when attempting subsequent mappings.

FIGS. 4A-4D together form a high level logical flowchart of an exemplary method of providing a user with intelligent access to a skilled consultant, according to an embodiment of the operation of the invention. According to the present disclosure, the exemplary method in FIGS. 4A-4D is implemented in SCH system 108 of FIGS. 1-3. After initiator block 400, problem analyzer 302 (FIG. 3) receives user input (e.g., text string) related to a user issue from the user. For example, the user input may include the text string, ‘I can not login to my system using SSH’. At block 404, problem analyzer 302 parses the text string for one or more keywords, which describe the user input. According to one embodiment, the parsing is performed using a Natural Language Parsing (NLP) tool that parses the text string and returns a breakdown of the natural language input. From the natural language input, problem analyzer 302 extracts the keyword(s). Using the exemplary text string listed earlier, such extracted keywords are ‘login’ and ‘SSH’. From block 404, the method continues to decision block 406, in which problem analyzer 302 determines whether a list or lists of problem domains associated with each keyword is available. If it is determined in block 404 that no list(s) of problem domain(s) are available, problem analyzer 302 prompts the user to modify the text string relating to the user issue (block 408) and control iteratively returns to block 402.

If it is determined at decision block 406 that a list of problem domain(s) associated with each keyword is available, the problem analyzer 302 extracts the list(s) of problem domains(s), as depicted in block 410. At decision block 412, problem analyzer 302 determines whether a single problem domain list or a plurality of different problem domain lists has been extracted. If a single problem domain list has been extracted, the method proceeds directly to block 418 (described in FIG. 4B). However, if different domain lists have been extracted, problem analyzer 302 intersects the different extracted lists of problem domains, as depicted in block 414. For exemplary purposes, the example assumes that more than one domain list has been extracted by problem analyzer 302. Thus, in the example presented, the first keyword, ‘login’, has a reference to a first problem domain list containing the problem domain in the database, ‘connection’. Moreover, the second keyword, ‘SSH’, has a reference to a second problem domain list containing the two problem domains, ‘connection’ and ‘security’.

Applying the teaching in block 414, problem analyzer 302 intersects the exemplary first and second problem domain lists. From block 414, the method continues to block 416, where a single, unique problem domain associated with the keyword(s) is mapped. Using the example described, the intersection of the first problem domain list and the second problem domain list maps to the ‘connection’ problem domain, since the ‘connection’ problem domain is shared by both extracted domain lists.

According to another embodiment of the disclosure, however, there are instances when problem analyzer 302 cannot intersect the different extracted lists of problem domains to map a single problem domain. This can result when there is no commonly shared problem domain between the various extracted problem domain lists. Under such circumstances, statistical priority data is taken from metrics module 318 (FIG. 3). The statistical priority data is utilized when problem analyzer 302 cannot intersect the different extracted lists of problem domains to map a single problem domain. Using the statistical priority data, problem analyzer 302 selects a single problem domain by prioritizing one problem domain over a different problem domain among the extracted problem domain list(s).

Once a single, unique problem domain has been mapped according to block 416, the method continues to block 418 of FIG. 4B. At block 418, skilled consultant selector 304 (FIG. 3) identifies a list of skill(s) and minimum proficiency skill level value for skill(s) required to solve the unique problem domain. For example, if the unique problem domain is ‘connection’, skilled consultant selector 304 may identify consultants having a network connectivity skill set having a minimum proficiency skill level value of 4 (e.g., assuming the proficiency skill level values range from 1 to 10; 10 indicating maximum proficiency). At block 420, the selected problem domain is mapped to a consultant set of at least one consultant. The consultant(s) from the consultant set are each associated with a list of one or more identified skills having a minimum proficiency skill level value required to solve the unique problem domain. From block 420, the method proceeds to decision block 422, where skilled consultant selector 304 determines whether at least one consultant satisfying all the required skill sets with the minimum proficiency skill level has been identified. If there are no consultants that satisfy all of the required skill sets, the method returns to block 408 of FIG. 4A via connector “A”.

When skilled consultant selector 304 determines that there is at least one consultant satisfying all of the required skills with a minimum proficiency skill level for each skill, the method continues to block 424 of FIG. 4C. At block 424, scheduler module 312 (FIG. 3) determines the time availability of the identified consultants in the consultant set. At decision block 426, scheduler module 312 determines, via consultant calendar interface 314 (FIG. 3), if the identified consultants in the consultant set are immediately available based on calendar system data from calendar 315 (FIG. 3). If there are identified consultants immediately available based on the calendar system data, scheduler module 312 determines whether the identified consultants in the consultant set are immediately available, for example, according to their availability status on IM system 316 (FIG. 3), as depicted in decision block 428. If the identified consultants are immediately available, for example, according to an availability status indicated by IM system 316, the method continues to block 430, where scheduler module 312 communicates a consultation request to the identified consultant(s) via IM system 316. In this regard, IM system 316 may communicate multiple consultation requests depending upon the number of identified consultants. Scheduler module 312 determines whether an identified consultant has accepted the immediate consultation request. According to one embodiment of the disclosure, the identified consultant whose acceptance is first received will retain ownership of the immediate consultation session with the user. If an identified consultant from the consultant set accepts the immediate consultation request, schedule module 312 communicates the consultation request to the user via IM system 316, as depicted in block 434. At decision block 436, scheduler module 312 determines whether the user has accepted the consultation request. If the user accepts the consultation request, an immediate consultation session between the identified consultant and the user is established and consultation information is communicated to the user, as depicted in block 438. It should be noted that the communication of consultation information between the available consultant and the user would occur in substantially real time via DPS 200 (FIG. 2). The method ends at termination block 454.

While the above description of the flow chart has been described during conditions when the identified consultants in the consultant set and the user are immediately available and accepting of an immediate consultation session, there are instances when an immediate consultation session is not possible. Referring to FIG. 4C, these instances include: (a) if the identified consultants are not immediately available based on calendar system data (decision block 426); (b) if the identified consultants are not immediately available according to the IM system 316 (decision block 428); (c) if the identified consultant as accepted the immediate consultation request within a timeout period (decision block 432); or (d) if the user has not accepted the consultation request within a timeout period (decision block 436). If any one of instances (a)-(d) is satisfied, the method continues to block 440 of FIG. 4D.

With reference now to block 440 of FIG. 4D, scheduler module 312 searches, via consultant calendar interface 314, for calendar 315 of consultant(s) in consultant set for available schedule time for consultation. Scheduler module 312 determines whether available schedule time for consultation is identified, as depicted in decision block 442. If no available schedule time is identified, scheduler module 312 communicates said lack of available schedule time (block 444) and the method ends at termination block 454. However, if available schedule time is identified, scheduler module 312 notifies the user via a Web interface of alternative schedule availability option(s) for access to consultant(s) in the consultant set. According to one embodiment, the Web interface can be housed within problem analyzer 302.

At block 448, scheduler module 312 receives a user selection of an alternative schedule time via IM system 316. Upon receipt of the user selection, scheduler module reserves via consultant calendar interface 314 an alternative time slot within calendar 315 of the selected consultant, as depicted in block 450. According to one embodiment, scheduler module 312 communicates via e-mail (using e-mail system 317 (FIG. 3)) a confirmation of the selected consultation session time period to both the user and the selected consultant. While the embodiment described employs e-mail system 317 to communicate with the user and/or consultant(s), it should be appreciated that other communication systems, such as IM system 316 and telephone messaging systems, can be used either alternatively or in conjunction with e-mail system 317. From block 452, the method ends at termination block 454.

Note that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method in a data processing system for providing a user with intelligent access to a skilled consultant, said method comprising:
in response to receiving a user input describing an issue about which consultation is desired, mapping said user input to at least a selected problem domain from among a plurality of problem domains;
based on a list of one or more skills for consulting in said selected problem domain, mapping said selected problem domain to a consultant set of one or more consultants associated with said one or more skills;
filtering said consultant set to determine whether at least one consultant in said consultant set is available to consult utilizing communication via said data processing system;
sending a consultation request to at least one available consultant in said consultant set; and
in response to receiving, from an available consultant, an acceptance of said consultation request, communicating consulting information between said available consultant and said user in substantially real time via said data processing system.

2. The method of claim 1, farther comprising extracting one or more keywords from a text string entered by said user, wherein each keyword is associated with a list containing at least one problem domain from among said plurality of problem domains.

3. The method of claim 1, wherein said mapping said user input to said selected problem domain from among said plurality of problem domains is based on an intersection of a first list containing at least one problem domain and a second list containing at least one problem domain.

4. The method of claim 1, wherein said selected problem domain is selected based on priority level data derived from a statistical database.

5. The method of claim 4, wherein said statistical database collects performance data associated with a consultation session between said user and said available consultant.

6. The method of claim 1, wherein each said skill is associated with a minimum proficiency skill level value.

7. The method of claim 1, wherein said filtering includes:
determining whether said at least one consultant in said consultant set is immediately available based upon a calendar of said at least one consultant;
in response to determining that said at least one consultant is immediately available based upon said calendar, determining whether said at least one consultant is immediately available to consult utilizing communication via said data processing system; and
in response to determining that said at least one consultant is immediately available to consult utilizing communication via said data processing system, directly querying said at least one consultant in the form of said consultation request to determine whether said at least one consultant is immediately available to consult.

8. The method of claim 1, wherein if it is determined after said filtering that said at least one consultant is not immediately available to consult, searching said calendar of said at least one consultant to identify available schedule time for consultation, and notifying said user of alternative schedule availability options for access to said at least one consultant.

9. A data processing system comprising:
a processor unit;
a memory coupled to the processor unit; and
a skilled consultant help (SCH) system executing on the processor unit and having executable code for:
in response to receiving a user input from a user describing an issue about which consultation is desired, mapping said user input to at a selected problem domain from among a plurality of problem domains;
based on a list of one or more skills for consulting in said selected problem domain, mapping said selected problem domain to a consultant set of one or more consultants associated with said one or more skills;
filtering said consultant set to determine whether at least one consultant in said consultant set is available to consult utilizing communication via said data processing system;
sending a consultation request to at least one available consultant in said consultant set; and
in response to receiving, from an available consultant, an acceptance of said consultation request, communicating consulting information between said available consultant and said user in substantially real time via said data processing system.

10. The data processing system of claim 9, said SCH system farther having executable code for extracting one or more keywords from a text string entered by said user, wherein each keyword is associated with a list containing at least one problem domain from among said plurality of problem domains.

11. The data processing system of claim 9, wherein said mapping said user input to said selected problem domain from among said plurality of problem domains is based on an intersection of a first list containing at least one problem domain and a second list containing at least one problem domain.

12. The data processing system of claim 9, wherein said selected problem domain is selected based on priority level data derived from a statistical database.

13. The data processing system of claim 12, wherein said statistical database collects performance data associated with a consultation session between said user and said available consultant.

14. The data processing system of claim 9, wherein each said skill is associated with a minimum proficiency skill level value.

15. The data processing system of claim 9, wherein said filtering includes:
determining whether said at least one consultant in said consultant set is immediately available based upon a calendar of said at least one consultant;
in response to determining that said at least one consultant is immediately available based upon said calendar, determining whether said at least one consultant is immediately available to consult utilizing communication via said data processing system; and
in response to determining that said at least one consultant is immediately available to consult utilizing communication via said data processing system, directly querying said at least one consultant in the form of said consultation request to determine whether said at least one consultant is immediately available to consult.

16. The data processing system of claim 9, wherein if it is determined after said filtering that said at least one consultant is not immediately available to consult, searching said calendar of said at least one consultant to identify available schedule time for consultation, and notifying said user of alternative schedule availability options for access to said at least one consultant.

17. A computer program product comprising:
a computer storage medium; and
program code on the computer storage medium that when executed provides the functions of:
in response to receiving a user input from a user describing an issue about which consultation is desired, mapping said user input to at least a selected problem domain from among a plurality of problem domains;
based on a list of one or more skills for consulting in said selected problem domain, mapping said selected problem domain to a consultant set of one or more consultants associated with said one or more skills;
filtering said consultant set to determine whether at least one consultant in said consultant set is available to consult utilizing communication via a data processing system;
sending a consultation request to at least one available consultant in said consultant set; and
in response to receiving, from an available consultant, an acceptance of said consultation request, communicating consulting information between said available consultant and said user in substantially real time via said data processing system.

18. The computer program product of claim 17, wherein said mapping said user input to said selected problem domain from among said plurality of problem domains is based on an intersection of a first list containing at least one problem domain and a second list containing at least one problem domain.

19. The computer program product of claim 17, wherein said selected problem domain is selected based on priority level data derived from a statistical database.

20. The computer program product of claim 17, wherein said filtering includes:
determining whether said at least one consultant in said consultant set is immediately available based upon a calendar of said at least one consultant;
in response to determining that said at least one consultant is immediately available based upon said calendar, determining whether said at least one consultant is immediately available to consult utilizing communication via said data processing system; and
in response to determining that said at least one consultant is immediately available to consult utilizing communication via said data processing system, directly querying said at least one consultant in the form of said consultation request to determine whether said at least one consultant is immediately available to consult.
